(19) United States
(12) Patent Application Publication
(10) Pub. No.: US 2015/0208103 A1
(43) Pub. Date: Jul. 23, 2015

(54) System and Method for Enabling User Control of Live Video Stream(s)

(71) Applicant: National University of Singapore, Singapore (SG)

(72) Inventors: Ravindra Guntur, Karnataka (IN); Arash Shafiei, Singapore (SG); Wei Tsang Ooi, Singapore (SG); Quang Minh Khiem Ngo, Singapore (SG)

(73) Assignee: National University of Singapore, Singapore (SG)

(21) Appl. No.: 14/420,235

(22) PCT Filed: Aug. 12, 2013
(86) PCT No.: PCT/SG2013/000341

§ 371 Date: Feb. 6, 2015

Related U.S. Application Data
(60) Provisional application No. 61/680,779, filed on Aug. 8, 2012.

(51) Int. Cl. H04N 21/214; H04N 21/2187; H04N 21/231; H04N 7/18; H04N 21/414; H04N 21/4728; H04N 21/845; H04N 19/436; H04N 21/2343

(52) U.S. Cl. CPC H04N 21/2143; H04N 19/436; H04N 21/2187; H04N 21/23109; H04N 21/234363; H04N 21/23439; H04N 21/41407; H04N 21/4728; H04N 21/8451; H04N 7/181; H04L 65/602

(57) ABSTRACT

There is provided a system for enabling user control of a live video stream, the system including: a processing module for obtaining offset data for each of a plurality of encoded video segments having a number of different resolutions of the live video stream, the offset data indicative of offsets of video elements in the encoded video segment; a storage medium for storing the encoded video segments and the corresponding offset data; a segment management module for receiving messages from the processing module relating to the availability of the encoded video segments and facilitating streaming of the encoded video segments to the user based on said offset data; and a user interface module for receiving a user request from a user with respect to the live video stream and communicating with the segment management module for streaming the encoded video segments to the user based on the user request. There is also provided a corresponding method and a computer program product comprising instructions executable by a computing processor to perform the method.

### FIELD OF INVENTION

The invention relates to a system and a method for enabling user control of live video stream(s), for example but not limited to, virtual zooming, virtual panning and/or sharing functionalities.

### BACKGROUND

Many network cameras are capable of capturing and streaming high-definition videos for live viewing on remote clients. Such systems are useful in many contexts, such as video surveillance, e-learning, and event telecast. Conventional techniques of enabling a user control of a live video stream would require the direct control of the video camera itself such as the physical zooming and panning functionalities of the video camera. However, this would require a one-to-one relationship between the user and the video camera, which is not feasible in a live video streaming to multiple users, such as for a sporting event or a webinar.

Thus, conventional techniques of live video streaming to multiple viewers generally do not allow viewer control of the live video stream. The viewer will simply be able to watch the content that is being streamed, without the ability to zoom into or pan around any arbitrary regions of interest to the viewer. For example, in an educational video, when a user is watching a live video lecture on a hand-held device, the user can see the lecturer and the board but may not be able to read what is written on the board. However, conventional techniques do not enable the user to zoom into an arbitrary region of interest on the board for a clearer view of the written material and pan to view another region of interest on the board as the lecture proceeds.

It is against this background that the present invention has been developed.

### SUMMARY

The present invention seeks to overcome, or at least ameliorate, one or more of the deficiencies of the prior art mentioned above, or to provide the consumer with a useful or commercial choice.

According to a first aspect of the present invention, there is provided a system for enabling user control of a live video stream, the system comprising:
a processing module for obtaining offset data for each of a plurality of encoded video segments having a number of different resolutions of the live video stream, the offset data indicative of offsets of video elements in the encoded video segment;
a storage medium for storing the encoded video segments and the corresponding offset data;
a segment management module for receiving messages from the processing module relating to the availability of the encoded video segments and facilitating streaming of the encoded video segments to the user based on said offset data; and
a user interface module for receiving a user request from a user with respect to the live video stream and communicating with the segment management module for streaming the encoded video segments to the user based on the user request.

Preferably, the encoded video segments are encoded based on a virtual tiling technique where each frame of the encoded video segments is divided into an array of tiles, and each tile comprising an array of slices.

In an embodiment, the processing module is operable to receive and process the live video stream into said encoded video segments at said number of different resolution levels.

In another embodiment, the system further comprises a camera for producing the live video stream and processing the live video stream into said encoded video segments at said number of different resolutions levels.

Preferably, the processing module is operable to parse the encoded video segments for determining said offsets of video elements in each encoded video segment.

Preferably, for each encoded video segment, the offset data corresponding to said encoded video segment are included in an index file associated with said encoded video segment.

Preferably, the segment management module comprises a queue of a predetermined size for storing references to the offset data and the encoded video segments based on the messages received from the processing module.

Preferably, the segment management module is operable to load the offset data referred to by each reference in the queue into a data structure in the storage medium for facilitating streaming of the encoded video segment associated with the offset data.

Preferably, the video elements in the encoded video segment comprise a plurality of frames, a plurality of tiles in each frame, and a plurality of slices in each tile.

Preferably, the offset data comprises data indicating byte offset of each frame, byte offset of each tile in each frame, and byte offset of each slice in each tile.

Preferably, the byte offsets of the video elements in the encoded video segment are determined with respect to a start of the encoded video segment.

Preferably, the user interface module is configured for receiving and processing the user request from the user with respect to the live video stream, the user request including an adjustment of region-of-interest coordinates, an adjustment of zoom level, and/or sharing the live video stream being viewed at the user's current viewing parameters with others.

Preferably, the viewing parameters include region-of-interest coordinates and zoom level determined based on the user request, and wherein a user viewing data, comprising the viewing parameters, is stored in the storage medium linked to the user.

Preferably, the user interface module is operable to update the user viewing data with the adjusted region-of-interest coordinates when the adjustment of the region-of-interest coordinates is requested by the user, and is operable to extract the tiles of the encoded video segments intersecting and within the adjusted region-of-interest coordinates for streaming to the user based on the offset data associated with the encoded video segments loaded on the storage medium.

Preferably, the user interface module is operable to update the user viewing data with the adjusted zoom level and region-of-interest coordinates when the adjustment of the zoom level is requested by the user, and is operable to extract the tiles of the encoded video segments at the resolution closest to the adjusted zoom level and intersecting and within the adjusted region-of-interest coordinates for streaming to the user based on the offset data associated with the encoded video segments loaded on the storage medium.

Preferably, the user interface module is operable to extract the viewing parameters from the user viewing data when the sharing of the live video stream with others is requested by the user, and to create a video description file comprising the viewing parameters for enabling a video footage to be reproduced or to create a video footage based on the viewing parameters, and wherein a reference data linked to the video description file or the video footage is created for sharing with said others to view the video footage.

Preferably, the system further comprises a display module for receiving the user request with respect to the live video stream and transmitting the user request to the user interface module, and for receiving and decoding tiles of the encoded video segments from the user interface module for displaying to the user based on the user request.

Preferably, the display module is operable to crop and scale the decoded tiles for display based on the user request for removing slices within the decoded tiles not within the region-of-interest coordinates.

Preferably, the display module is operable to, upon receiving the user request and before the arrival of the tiles having a higher resolution corresponding to the user request, decode and display other tiles having a lower resolution at a same position as the tiles.

Preferably, the system is operable to receive and process a plurality of the live video streams or encoded video segments from a plurality of cameras for streaming to multiple users.

According to a second aspect of the present invention, there is provided a method of enabling user control of a live video stream, the method comprising:
providing a processing module for obtaining offset data for each of a plurality of encoded video segments having a number of different resolutions of the live video stream, the offset data indicative of offsets of video elements in the encoded video segment;
storing the encoded video segments and the corresponding offset data in a storage medium;
providing a segment management module for receiving messages from the processing module relating to the availability of the encoded video segments and facilitating streaming of the encoded video segments to the user based on said offset data; and
providing a user interface module for receiving a user request from the user with respect to the live video stream and interacting with the segment management module for streaming the encoded video segments to the user based on the user request.

According to a third aspect of the present invention, there is provided a computer program product, embodied in a computer-readable storage medium, comprising instructions executable by a computing processor to perform the method according to the second aspect of the present invention.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 depicts an exemplary system for enabling user control of a live video stream according to an embodiment of the present invention;

FIG. 2A depicts a flow diagram illustrating an exemplary process of a processing engine in the exemplary system of FIG. 1;

FIG. 2B depicts a schematic block diagram of an exemplary implementation of the process of FIG. 2A;

FIG. 2C depicts a schematic drawing illustrating encoded video segments and the video elements therein according to an embodiment of the present invention;

FIG. 3A depicts a flow diagram illustrating an exemplary process of determining offsets of video elements in the encoded video segment according to an embodiment of the present invention;

FIG. 3B depicts an exemplary data structure of the offset data according to an embodiment of the present invention;

FIG. 3C depicts a data structure of FIG. 3B with exemplary values;

FIG. 4A depicts a flow diagram illustrating an exemplary process of the segment management module in exemplary system of FIG. 1;

FIG. 4B depicts an exemplary representation of the data structure loaded in the storage medium in the exemplary system of FIG. 1;

FIG. 5A depicts a flow diagram illustrating an exemplary process of the streaming module in the exemplary system of FIG. 1;

FIG. 5B depicts a schematic drawing of an exemplary encoded frame with a region-of-interest shown corresponding to that selected by a user;

FIG. 6 depicts a schematic block diagram of an exemplary implementation of the process of the segment management module and the user interface module in the exemplary system of FIG. 1 for streaming a live video to a user;

FIG. 7 depicts an exemplary method of enabling user control of a live video stream according to an embodiment of the present invention; and

FIG. 8 depicts an exemplary computer system for implementing the exemplary system of FIG. 1 and/or the exemplary method of FIG. 7.

### DETAILED DESCRIPTION

Embodiments of the present invention provide a method and a system for enabling user control of live video stream(s), for example but not limited to, virtual zooming, virtual panning and/or sharing functionalities.

By way of an example only, in a live educational video stream to multiple students when a user is watching the lesson on a mobile device such as a laptop or a hand-held device, the user may be able to see the lecturer and the board but may not be able to read the material written on the board. With the method and system according to embodiments of the present invention, the user is able to zoom into an arbitrary region of interest on the board for a clearer view of the written material and pan around to view another region of interest on the board as the lecture proceeds. As another example, in a live sporting event video stream to multiple viewers, the viewer watching the live video stream is able to zoom in to get a closer look of a person of interest and pan around the scene of the event to examine various regions of interest to the viewer.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

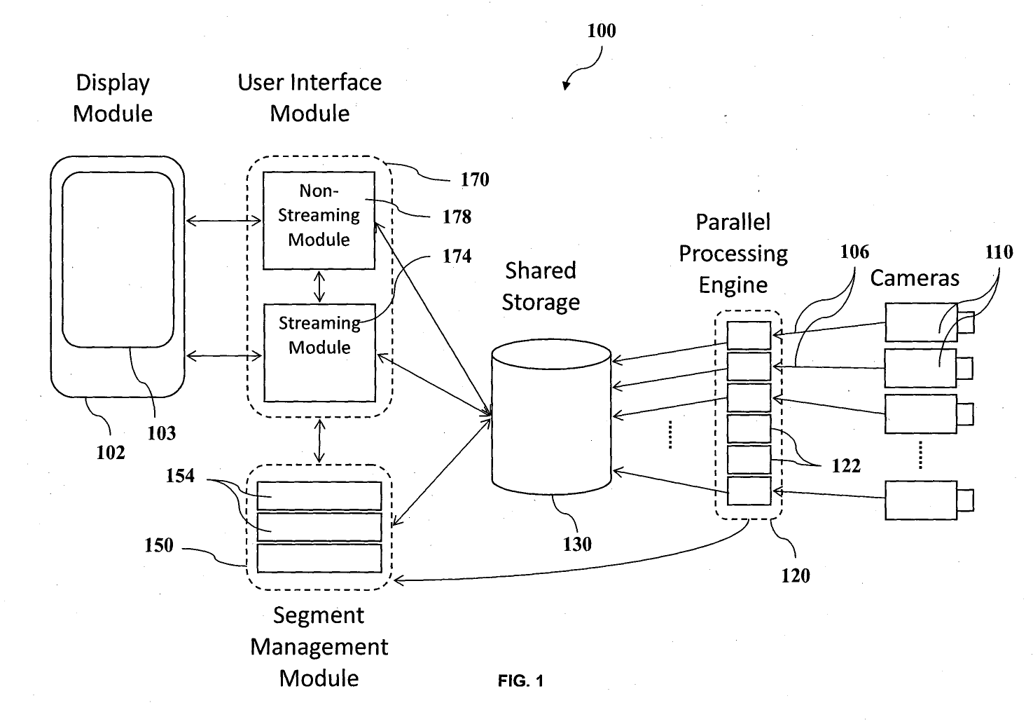

FIG. 1 depicts a schematic block diagram illustrating an exemplary system 100 for enabling user control of live video stream(s) according to an embodiment of the present invention.

As a general overview, the system 100 is operable to receive and process compressed or uncompressed video feeds/streams 106 from multiple cameras 110 for streaming to the one or more users on a display module 102. The received video streams 106 are converted into video segments and encoded at multiple frame dimensions (i.e., width and height, or spatial resolutions) using motion vector localization. In one embodiment, the motion vector localization is in the form of rectangular regions called “tiles” which will be described in further detail below. Subsequently, the encoded video segments are parsed to identify byte offsets (i.e., offset data) of the video elements (e.g., frames, tiles and macroblocks or slices) in each video segment from the start of the video segment. In an embodiment, for each video segment at each resolution level, the byte offsets of every video element therein are stored in the form of a description/index file (described in further detail below) associated with the video segment. In another embodiment, the index file and the video segment are stored in a single file.

The system 100 is operable to stream the encoded video segments to one or more users who wish to watch the live video from the cameras 110 on one or more display modules 102. As there are multiple video feeds 106 that are processed into encoded video segments in parallel, the users may choose which video feed 106 they would like to view. In an embodiment, the encoded video segments with the lowest frame dimension (i.e., lowest resolution) are first streamed to the user on the display module 102 to provide them with the full captured view while minimising the amount of data required to be transmitted (i.e., minimising bandwidth usage). The user may then (by interacting with the display module 102 via various forms of command inputs known in the art such as a mouse and/or a keyboard communicatively coupled to the display module 102 or a gesture on a touch-sensitive screen of the display module 102 such as by finger(s) or a stylus) select any region-of-interest (RoI) of the live video stream and request the system 100 to stream this RoI alone. This selected RoI will be transmitted to the display module 102 of the user at a higher resolution than the initial video stream at the lowest resolution. To achieve this, the system 100 is operable to crop a rectangular region from the encoded video segments with higher resolution corresponding to the RoI selected by the user and then stream the cropped region to the display module 102 used by the user. The cropped region will be fitted onto the display module 102 and displayed. In this manner, the user will simply experience a zoomed-in effect without any interruption in the viewing experience although it is a new video stream cropped from the encoded video segments having a higher resolution. This may be referred to as a virtual zoom of the live video stream. In addition, the user may wish to pan the RoI around. To achieve this, the system 100 is operable to stream cropped regions of encoded video segments with higher resolution corresponding to the series of RoIs indicated by the user's panning action. This may be referred to as a virtual pan in the live video stream. In embodiments of the present invention, the cropping of the encoded video segments is performed in real-time by using the index file as briefly described above and will be described in further detail below. In an embodiment, for increasing efficiency, the index file may be loaded/stored in a storage medium into a data structure easily addressable using hashes. This will also be described in further detail below.

In an embodiment, the system 100 is also operable to facilitate the sharing of users' video views (i.e., footages of the live video stream viewed by the users) with others. To initiate sharing, the user viewing the live video stream at certain/particular viewing parameters (e.g., a particular virtual zoom level, a particular virtual pan position, and a particular camera providing the live video stream 106 being viewed by the user) instructs the system 100 via a user interface on the display module 102 as described above to start sharing or saving. In this regard, the system 100 has information indicative of the user's current viewing parameters. In an embodiment, when requested by the user, encoded video segments corresponding or closest to the virtual zoom level and virtual pan position requested are cropped and concatenated to form a new video footage. The new video footage may then be saved to be used/retrieved at a later stage or shared with others as desired by the user. In another embodiment, information indicative of the user's viewing parameters at any stage requested by the user may be recorded/stored in a structured data, e.g., a video description file. The structured data may then be used later to retrieve the video footage and shared using any sharing mechanisms known in the art such as HTTP streaming and file-based uploading.

It will be appreciated to a person skilled in the art that since the live video streams from the cameras 110 are processed by the system 100 before being streamed to the users, there is inevitably a slight delay (e.g., 0.5 to 5 seconds) in delivering the live video stream to the users. The slight delay corresponds to the time required to process the live video streams from the cameras 110 such as segmentation, tile encoding, and generation of index file. As the delay is small and unavoidable, the video streams delivered to the users on the display module 102 by the system 100 may still be considered as live, but may be more specifically stated as near-live or delayed-live.

The exemplary system 100 will now be described in further detail below with reference to FIG. 1. The system 100 comprises a processing module 120, a computer readable storage medium 130, a segment management module 150, and a user interface module 170. The system 100 may further comprise one or more cameras 110 (e.g. one for each desired camera angle or location) and/or one or more display modules 102 (e.g., one for each user wishing to view the live video stream). However, this is not necessary as the camera(s) 110 and/or the display module(s) 102 may be separately provided and communicatively couplable to the system 100 to stream the live video from the camera(s) 110 to the user(s).

In an embodiment, the processing module 120 is operable to receive live video streams 106 from the one or more cameras 110 and encode them into video segments having different resolutions. In an embodiment, the highest resolution corresponds to the resolution of the video streams 106 as generated by the cameras 110, and the other lower resolutions may each be determined as a fraction of the highest resolution. For example and without limitation, the other lower resolutions may be set at ½, ¼, and ⅛ of the highest resolution. In an embodiment, these fractions may be determined based on the frequencies of requested zoom levels by the users. For example, lower resolutions at certain fractions of the highest resolution may be set corresponding or closest to the zoom levels frequently requested by the users. It will be appreciated to a person skilled in the art that the resolutions and the number of resolution levels may be configured/determined as appropriate and based on the processing capability of, for example, a computer for implementing the system 100 and the amount of storage space of the computer readable storage medium 130 of the system 100.

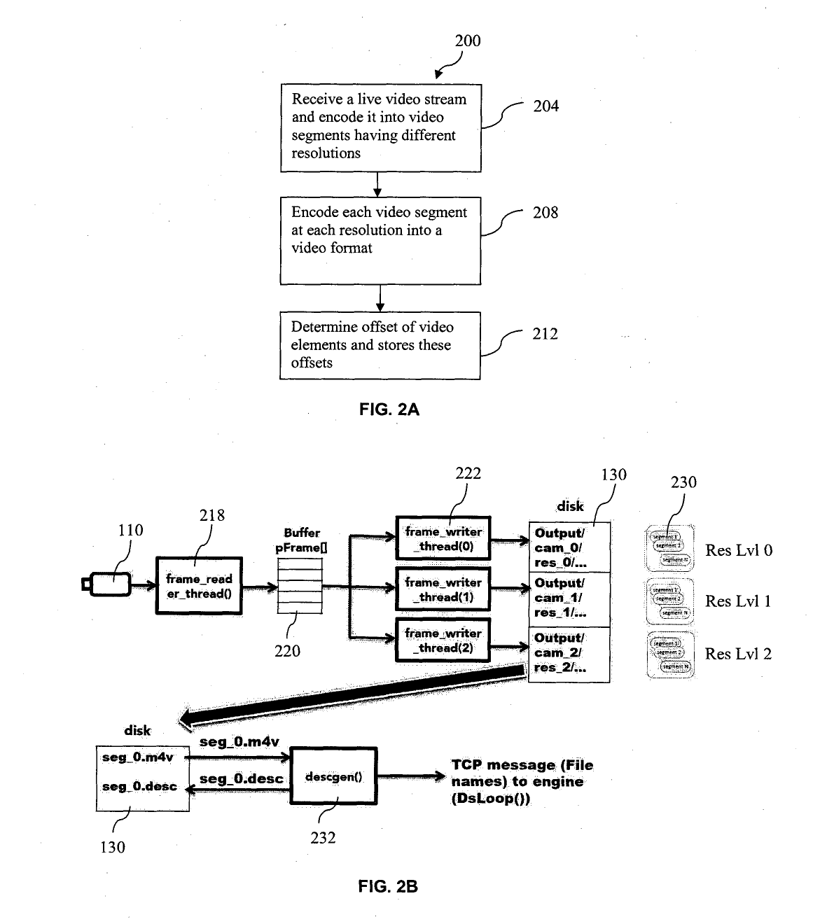

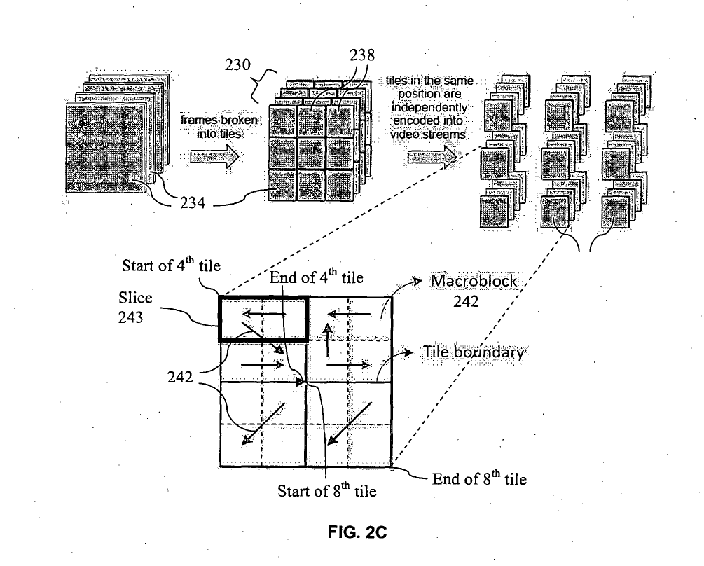

As shown in FIG. 1, the processing module 120 may comprise a plurality of parallel processing engines 122, each for receiving and encoding a live video stream 106 from a respective camera 110. FIG. 2A depicts a flow diagram illustrating a process 200 of the processing engine 122. In a first step 204, the processing engine 122 receives a live video stream 106 and encodes it into video segments 230 having different resolutions (e.g., see FIG. 2B). Specifically, the processing engine 122 reads frames from the live video stream 106 and converts them into frames with a predetermined number of different resolutions (corresponding to the predetermined number of zoom levels desired). When a predetermined number of frames are accumulated, the frames at each resolution are stored in the storage medium 130 as a video segment 230 for each resolution. FIG. 2B depicts a schematic block diagram of this process for an example where the processing engine 122 encodes the live video stream 106 into three resolution levels (Resolution level 0, Resolution level 1,and Resolution level 2). As shown in FIG. 2B, three write threads 222 are initiated to create frames of three different resolutions, respectively. The video segments (1 to N) 230 for each resolution illustrated schematically in FIG. 2B are stored in the storage medium 130. For example and without limitation, each video segment 230 may be 1 second in duration. According to embodiments of the present invention, it is desirable to minimise the duration of each video segment 230 since producing video segments 230 introduces a delay to the live video streaming to the user.

In a second step 208, the processing engine 122 encodes each video segment 230 at each resolution into a video format (for example, but not limited to, a MPEG video file) using virtual tiling. In virtual tiling, each frame 234 is configured or broken into an array or a set of rectangular tiles 238, and each tile 238 comprises an array of macroblocks 242 as illustrated in FIG. 2C. In an embodiment, the tiles 238 are regular in size and non-overlapping. In another embodiment, the tiles 238 may be irregular in size and/or may overlap one another. With this virtual tiling structure, during encoding, the motion vectors 252 are limited within the tile 238 which they belong and cannot reference a macroblock 242 in another tile 238. Accordingly, tile information can be stored on a direct access structure thereby enabling tiles 238 corresponding to user's request to be transmitted to the user within a minimum/reasonable delay. Without this virtual tiling, one must calculate all dependencies of motion vectors on a tree structure which is time consuming process. Depending on the video format, the macroblocks 242 contained in a tile may be either encoded in a single slice (e.g., using MPEG-4 flexible macroblock ordering), or encoded as multiple slices such that the macroblocks 242 belonging to different rows belong to different slices. For example and without limitation, FIG. 2C illustrates a tile 238 comprises an array of four macroblocks 242 (i.e., 2×2). In this example, the array of four macroblocks 242 may be encoded together as a single slice (not shown) or may be encoded into two slices, a slice 243 for each row of macroblocks 242 in the tile 238 as illustrated in FIG. 2C. This advantageously eliminates the variable length code (VLC) dependency, thereby removing the need to maintain a frequently changing dependency tree that is difficult to build and maintain in a live video streaming.

In an embodiment, the above-described steps 204, 208 may be implemented in the camera 110 instead of being implemented in the processing module 120 of the system 100. Therefore, the processing module 120 of the system 100 would receive the encoded video segments 230 with virtual tiling from the camera 110 and may thus proceed directly to step 212 described below. This will advantageously improve the delay of the system in the live video streaming as mentioned previously.

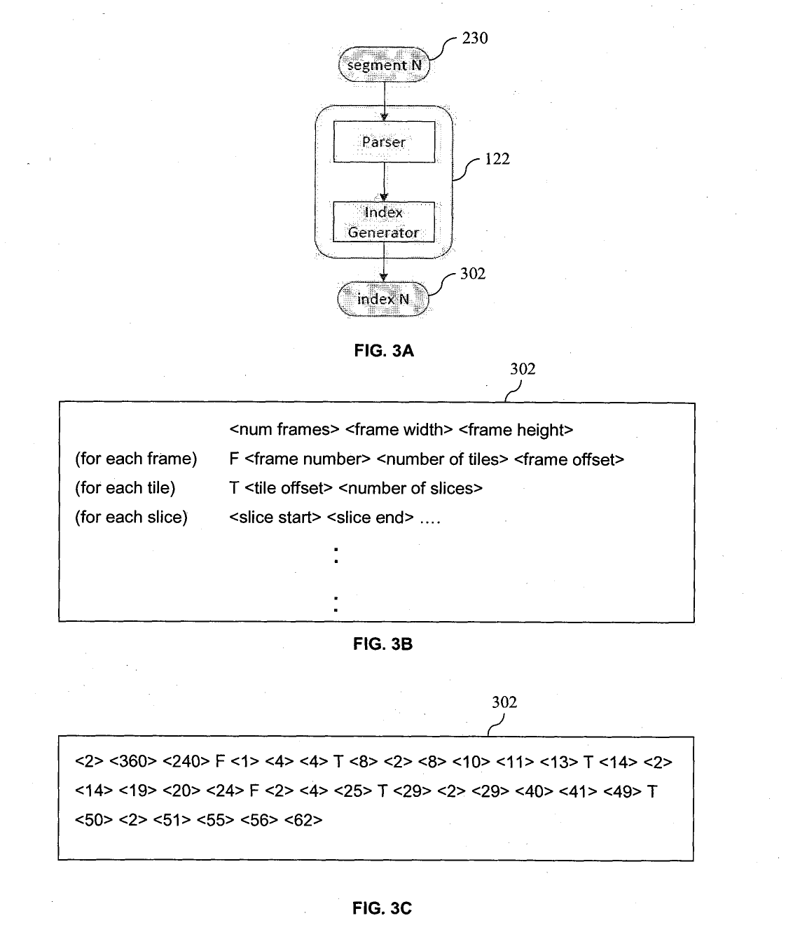

In a third step 212, the processing engine 122 determines the byte offsets (i.e. offset data) of the video elements (e.g., frame, tile and macroblock or slice) in each video segment 230 and stores this data as a description or an index file 302. This process is schematically illustrated in FIG. 3A. More specifically, the processing engine 122 reads the encoded video segments 230 and parses the video elements therein without fully decoding video segment 230. In an embodiment, for each encoded video segment 230, the processing engine 122 determines the byte offset of the starting byte of each frame 234 from the start of the video segment 230. Then, for each frame 234, the processing engine 122 determines the starting byte offset and the length (in bytes) of each slice 243 in the frame 234 it encounters. From adding the starting byte offset and the length, the ending byte offset can be computed. The slices 243 are then grouped into tiles 238 based on their position in the frame 234 in a data structure. The byte offset of the top-left most slice 243 in each tile 238 is assigned as the tile offset. In an embodiment, the frame offsets in each video segment 230, tile offsets in each frame 234, and slice offsets in each tile 238 are written to an index file 302 in the following exemplary data structure as shown in FIG. 3B where:
<num frames> denotes the number of frames in the video segment 230;
<frame width> and <frame height> denote the width and height of the frames 234 (in pixel units);
<frame number> denotes the nth frame 234 in the video segment 230;
<number of tiles> denotes the number of tiles 238 in the frame 234;
<frame offset> denotes the byte offset of the frame 234 from the start of the video segment 230;
<tile offset> denotes the byte offset of the tile 238 from the start of the video segment 230;
<number of slices> denotes the number of slices in the tile 238;
<slice start> denotes the byte offset of the start of the slice from the start of the video segment 230; and
<slice end> denotes the byte offset of the end of the slice from the start of the video segment 230.

For illustration purposes only, FIG. 3C shows an exemplary data structure of the index file 302 for a video segment 230 having two frames 234 with a resolution of 360 x 240 pixels, whereby each frame 234 has four tiles 238, and each tile 238 has two slices.

It will be appreciated to a person skilled in the art that the index file 302 is not limited to the exemplary data structure as described above and may be modified accordingly depending on the desired video format.

In another embodiment, the offsets of the frames 234, tiles 238, and slices 243, can be recorded in an index file 302 in the process of encoding the live video stream 106 instead of in the process of parsing the encoded video segment 230. This will advantageously improve the efficiency of the system 100 as the encoded video segments 230 need not be read an additional time from the storage medium 130.

After generating the encoded video segment 230 and the associated index file 302, the processing engine 122 sends them to the storage medium 130 for storage and also sends a message informing the availability of a new video segment to the segment management 150 described below. In an embodiment, the message comprises a video segment filename and an index filename of the video segment 230 and the index file 302 stored in the storage medium, respectively.

An exemplary implementation of the above-described functions of the processing engine 122 will now be described with reference to FIG. 2B for illustration purposes only and without limitation. The processing engine 122 creates one frame reader thread (frame_reader_thread( )) 218 for reading frames of the live video stream 106 from the cameras 110 and three frame writer threads (frame_writer_thread( )) 222 (one for each zoom level), and initializes semaphores and other data structures. The frames are stored in a buffer (Buffer_pFrame( )) 220 which is shared with the frame writer threads 222. The three frame writer threads 222 read frames from the buffer 220 and create frames of three different resolutions in this example. When a predetermined number of frames are accumulated, these frames are written to the storage medium 130 as a video segment 230 in the m4v video format as an example. For example, the video segments 230 may be written in the folder output/cam_i/res_j/, where i=0 to ncamera (number of cameras 110), j=0 to nlevel (number of resolution levels). Once the video segments 230 are written to the storage medium 130, the frame writer threads 222 invokes an description/index file generation thread (descgen( )) 232 which parses the encoded video segments 230, and extracts information (such as frame offsets, tile offsets, and slice offsets) required for streaming, and writes the information into a description/index file in the same folder as the associated video segment (e.g., seg_{—}0.m4v, seg_{—}0.desc). Subsequently, the frame writer thread 222 sends a message (e.g., TCP message) to the segment management module 150 indicating the availability of the video segment 230 for streaming.

Referring to the exemplary system 100 illustrated in FIG. 1, the segment management module 150 is operable to listen for messages transmitted from the processing module 120. The segment management module 150 comprises a plurality of management engines 154, each for processing messages derived from the video stream 106 of a particular camera 110. Each management engine 154 maintains a queue 402 of a predetermined size containing references to all encoded video segments 230 stored in the storage medium 130 corresponding to the messages recently received.

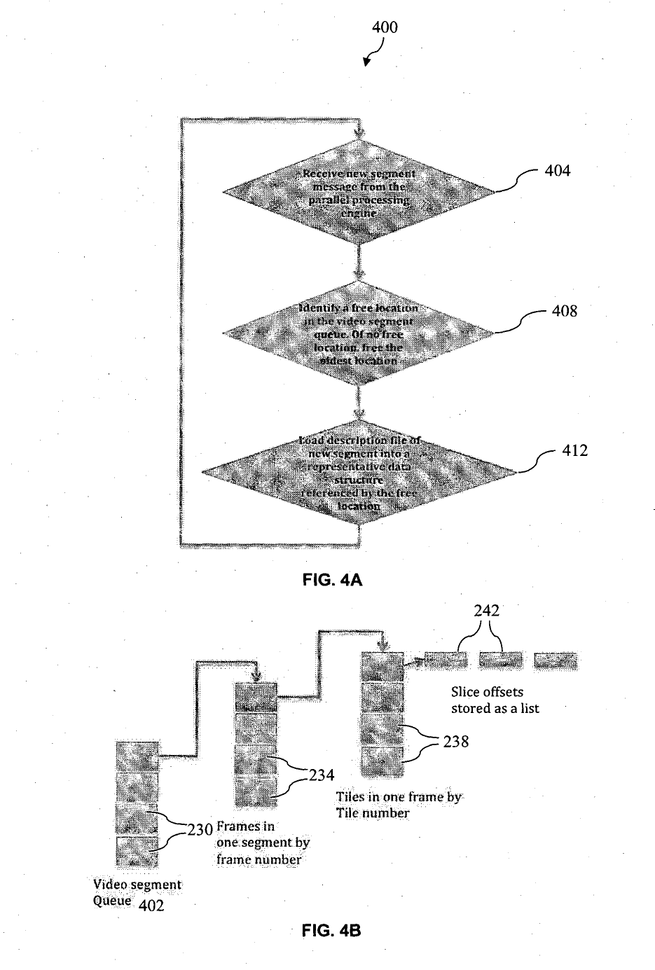

FIG. 4A depicts a flow diagram illustrating a process 400 of the segment management module 150. In a first step 404, the management engine 154 receives a message informing the availability of a new video segment from the processing module 120. In a second step 408, the management engine 154 finds a space or a location in the queue 402 for referencing the new video segment 230 stored in the storage medium. For example, the location in the queue 402 may be selected for storing the reference to the new video segment 230 if it is not being occupied. If all locations in the queue 402 are occupied by data (existing references), the oldest data in the queue 402 will be overwritten with the reference to the new video segment 230. Preferably, the queue 402 is a circular buffer (not shown) with a predetermined size. In this regard, assuming video segments 230 of 1 second each, by setting the buffer size to x, the queue 402 will have x seconds of fresh video in the buffer. In a third step 412, with the reference to the new video segment stored in the queue 402, the processing engine 154 loads the index file 302 associated with the new video segment 230 referred to by the reference into a data structure in the storage medium 130. FIG. 4B illustrates an exemplary representation of the data structure loaded in the storage medium 130. This data structure is used to facilitate streaming of the video segments to the user.

The user interface module 170 is operable to receive and process user requests, such as requests to stream video, adjust viewing parameters (e.g., zoom and pan), and share and/or save video. As described hereinbefore, the user may send user requests to the system 100 by interacting with the display module 102 communicatively coupled to the system 100 via various forms of command inputs such as a gesture on a touch-sensitive screen 103 of the display module 102. In an embodiment, the user interface module 170 comprises a streaming module 174 for processing requests relating to the streaming of video segments 230 to the user and a non-streaming module 178 for processing requests not relating to the streaming of video segments to the user, such as sharing and saving the video.

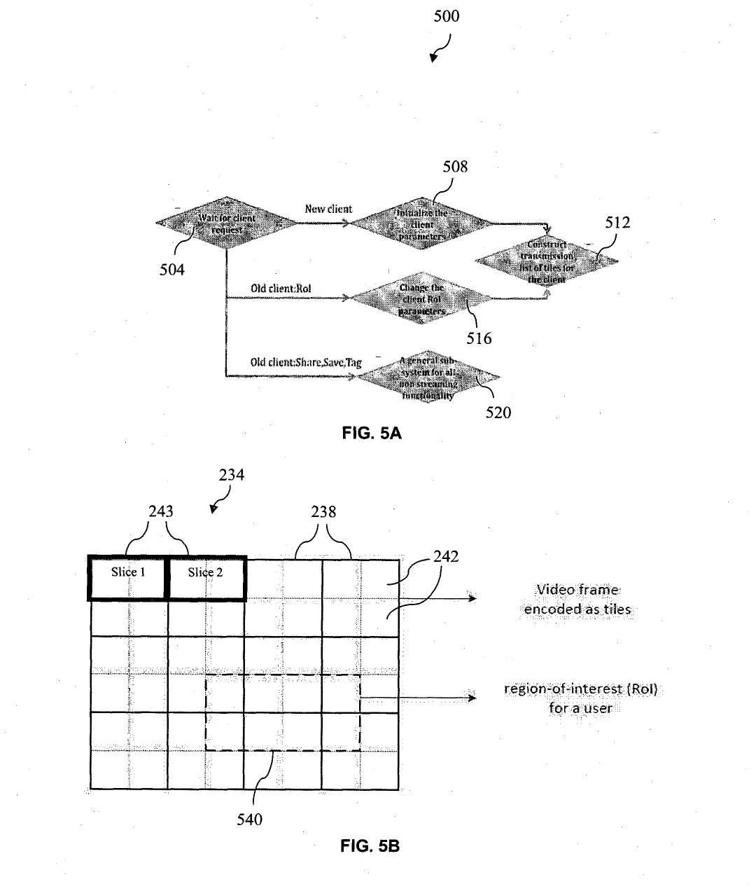

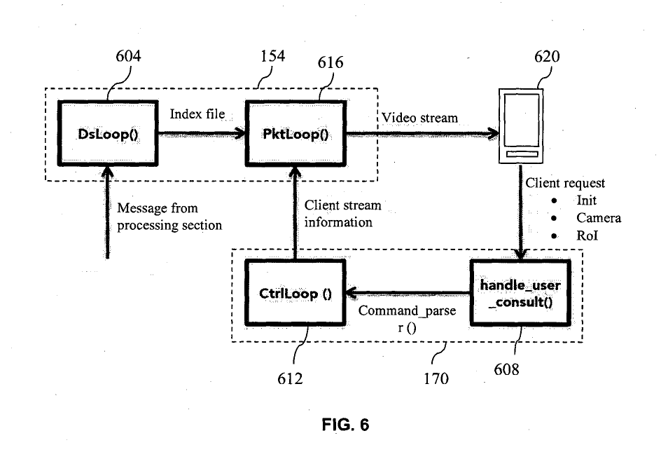

FIG. 5A depicts a flow diagram illustrating a process 500 of the streaming module 174. In a first step 504, the streaming module 174 listens for a user request. The display module 102 (or any computing device communicatively coupled to the display module 102) sends user request to the system 100 by communicating with the user interface module 170, and in particular the streaming module 174, based on any communication protocol known in the art. In a step 508, when the user requests for initializing a session for live streaming, the streaming module 174 initializes all the viewing parameters/settings required for streaming the live video to display module 102 of the user. In an embodiment, the viewing parameters include the camera number (i.e., a reference data indicative of the selected camera 110), the zoom level and the RoI coordinates. Preferably, the system 100 stores user data comprising information indicative of the user's current viewing parameters. Furthermore, the system 100 preferably stores a list of all the users indexed by user's IP address and port number in the storage medium 130 to facilitate communications with the display modules 102 of the users. Subsequently, the streaming module 170 streams the encoded video segments 230 having the lowest resolution to the user. To do this, at step 512, the streaming module 170 is operable to construct a transmission list of tiles 238 for streaming to the user. For this purpose, the streaming module 170 uses a queue 402 of the segment management module 230 in order to stream the most recent encoded video segments 230 to the user. At this stage, since no particular RoI has been selected by the user, the streaming module 170 streams the complete/full encoded video segments 230 having the lowest resolution to the user.

At step 516, when the user requests for an update for his/her view (i.e., viewing parameters), such as changes in RoI coordinates, zoom level and/or camera number, the user's data will be updated and the live video stream being streamed to the user will be calculated based on the updated user's data. For example, if the user requests to change to a camera 110, the video segments 230 that correspond to the lowest resolution level of the selected camera 110 will be chosen for transmission based on the updated user's data. If the user pans (thereby changing the RoI coordinates), this does not result in any change in the video segments 230 being used, but the list of tiles 238 selected from the video segments 230 for streaming to the user will change in accordance with the changes to the RoI coordinates. This will be described in further detail in relation to step 512 below. If the user requests a zoom-in or zoom-out, then the video segments 230 at the resolution level corresponding or closest to the zoom level requested by the user will be chosen for transmission to the user. A zoom-in request will lead to video segments 230 encoded at higher resolution level to be transmitted, unless the highest resolution level encoded has already been chosen, in which case the video segment 230 with the highest resolution will continue to be transmitted. Similarly, a zoom-out request will lead to video segments 230 encoded at a lower resolution level to be transmitted, unless the lowest resolution level encoded has already been chosen, in which case the lowest resolution level will continue to be transmitted.

After the video segments 230 encoded from the live video stream 106 of the selected camera 110 at the desired resolution level have been determined, the process proceeds to step 512 described above for constructing a transmission list of tiles 238 for streaming to the user. FIG. 5B shows a schematic diagram of an exemplary encoded frame 234 with a RoI 540 corresponding to that selected by the user. In the exemplary embodiments, all the tiles 238 intersecting with the RoI 540 are included in the transmission list for streaming to the user. Therefore, in the exemplary encoded frame 234 shown in FIG. 5B, the bottom-right six tiles 238 (i.e., tiles at (2, 2), (2, 3), (2, 4), (3, 2), (3, 3), and (3, 4)) intersecting with the RoI 540 are included in the transmission list for streaming to the user. The tiles 238 required to be sent to the user are extracted from the video segments 230 stored in the storage medium 130 based on the index file 302 loaded on the storage medium as described above.

It will be appreciated to a person skilled in the art that the display module 102 comprises a display screen 103 and may be part of a mobile device or a display of a computer system known in the art for interacting with the system 100 as described herein. The mobile device or the computer system having the display module 102 is configured to receive and decode the tiles 238 transmitted from the system 100 and then displayed to the user. The decoded tiles may be cropped and scaled so that only the RoI requested by user are displayed to the user. The user also interacts with the display module to update his/her view, such as changes in RoI coordinates, zoom level and/or camera number via any form of command inputs as described above. The display module 102 is configured to transmit the user requests/inputs to the user interface module 170 using, for example, Transmission Control Protocol (TCP). The user inputs will be processed/handled by the streaming module 174 in the manner as described herein such as according to process 500 illustrated in FIG. 5A.

It will be appreciated to a person skilled in the art that there is a small interaction delay between the display module 102 receiving the user inputs and displaying a new set of tiles transmitted by user interface module 170 in response to the user inputs. This time delay is on various factors such as the network round-trip-time (RTT) between the display module 180 and user interface module 170, and the processing time at the display module 180 and user interface module 170. In an embodiment, to reduce the user's perception of this delay, the display module 102 is configured to immediately, upon receiving the user inputs, present the current tiles being played back in a manner consistent with the user inputs (either virtual pan, virtual zoom, or change camera), without waiting for the new tiles to arrive. In this regard, for example, the display module 102 may be configured to operate as follows. If a tile at the same position but different resolution is currently being received, this tile is scaled up or scaled down to fit into the display and current zoom level. If no existing tiles being received share the same position with the new tile, before the new tile arrives, the display module 102 fills the position of the new tile with a solid background color (for example and without limitation, black). In another embodiment, the processing module 120 encodes each of the input video streams 106 into a thumbnail version with low spatial and temporal resolution (for example and without limitation, 320×180 at 10 frames per seconds). The thumbnails are stored on the storage medium 130 and managed by the segment management module 150 in the same manner as described above. The user interface module 170 constantly transmits these thumbnail streams to the users regardless of the user inputs. Accordingly, there is always a tile being received at the same position as any new tile requested.

In an embodiment, as mentioned previously, the system 100 is also operable to facilitate the sharing of users' video views (i.e., footages of the live video stream viewed by the users) with others. In this regard, when the user sends a request to the system 100 to share the footages of the live video stream viewed by the user, the process proceeds to step 520. In step 520, the user request is transmitted to a non-streaming module 178 for processing which will be described below. In embodiments, instead of or in addition to sharing, the user may also save or tag the video.

The non-streaming module 178 is operable to communicate with the streaming module 174 for receiving the user request for saving, sharing and/or tagging the currently viewed live video stream. In the case of saving the currently viewed live video stream, the non-streaming module 178 extracts the information associated with the user's current viewing parameters (including the number of the video segment, the camera currently providing the live video feed, the zoom level and the RoI coordinates). This information is then stored on a user request description file at the storage medium 130 of the system 100. A file ID of this video description file is then provided to the user as a reference for retrieval of the video in the future.

For exemplary purpose only, the structure of the video description file may be in the following format. The first line includes the identity (e.g., user's email address) of the user. The second line includes the viewing parameters (e.g., RoI coordinates, zoom level, and camera number) at the time when saving or sharing is requested. The third and subsequent lines each include a trace/record of the user request/input. The record starts with the presentation timestamp of the video at the time the user input is read on the display module 102, followed by the action specified by the user input (e.g., either “ZOOM” for zooming in or out, “PAN” for panning, and “CAMERA” for switching to another camera). If the action is “ZOOM”, the record is followed by the coordinates of the RoI, followed by the zoom level. If the action is “PAN”, the record is followed only by the coordinates of the RoI. If the action is “CAMERA”, the record is followed by the new camera number. The content of the video description file therefore includes a trace of all the user interactions (and the associated viewing parameters at that time) during a period of the live video stream which the user would like to save and/or share.

In this embodiment, the video footage can be calculated based on the video description file by replaying the trace of the user interactions, and applying each of the action recorded stored in the video description file on the video segments 230 on the storage medium 130. In another embodiment, the video requested by the user to save or share may be physically stored on the storage medium 130 or at a server (not shown) external to the system 100.

In the case of sharing the currently viewed live video stream, the above described process of saving will be performed and the file ID corresponding to desired video or video description file to be shared can be provided to others as desired. Advantageously, videos in accordance with the user's viewing parameters may be shared.

By way of an example only and without limitation, FIG. 6 illustrates a schematic block diagram of an exemplary process/implementation of the segment management module 150 and the user interface module 170 for streaming a live video to a user. After a processing engine 122 of the processing module 120 finishes writing video segments and the associated index file 302 to the storage medium 130, the processing engine 122 opens a TCP socket and sends a message (with the video segment and index filenames) to a corresponding management engine 154 of the segment management module 150 to inform the availability of a new video segment 230 to be streamed. In the example of FIG. 6, an engine thread (DsLoop( )) 604 of the segment management module 150 receives the message and proceeds to load the index file in the storage medium 130 corresponding to the new video segment received into a data structure (e.g., see FIG. 4B), along with the name of the corresponding video segment. In the example, every camera has a corresponding engine thread 604 in the segment management module 150, therefore, if there are two cameras connected to the system with two instances of processing engine running, the segment management module 150 will create two instances of the engine thread 604. The data structure is shared with other threads of the segment management module 150 to facilitate streaming of the video segments.

The processing engine of the segment management module 150 interacts with the user interface module 170 to stream the requested live video segments to the user at the desired viewing parameters (e.g., zoom level and RoI). The user sends a TCP message to the server for a new connection, to change the RoI, or change camera. The TCP message from the client is received by the user interface module 170, and in particular, the streaming module 174. In the example of FIG. 6, a user support thread (handle_user_consult( )) 608 of the streaming module receives the TCP message and invokes a parse function (parse_command( )). The parse function checks the camera number to which the message belongs, and passes the user request to the corresponding control thread (CtrlLoop( )) 612. There is one control thread 612 for each camera 110. If the request is for new connection, the control thread 612 creates a new streaming thread (PktLoop( )) 616 to stream video to the requesting user and adds the user information to the user list stored in the storage medium 130. For all other requests, such as change of ROI, change of camera etc., the control thread (CtrlLoop( )) 612 modifies stream information for the corresponding user in the user list. The streaming thread 616 gets the stream information (ROI etc.) from the user data and locates the corresponding entry in the data structure. With the information in data structure, the streaming thread 616 reads the video segment 230 into a buffer and calls a packet retriever function (pick_stpacket( )) for each frame of the video segment. The packet retriever function returns the packets need to be streamed to the user. The buffer returned by the packet retriever function is streamed to the user through a UDP socket. For example and without limitation, RTP may be used to stream the packets.

An exemplary procedure to stream video using RTP will now be described. 12 byte RTP header is added to each video packet to be sent over the UDP socket described above. In an embodiment, the SSRC field of the RTP header is chosen as the location of the user in the user table. It can be changed to the camera number to point to the actual source of the video. While other fields of the header are chosen with usual default values, it is necessary to dynamically update marker bit, sequence number, and time stamp. For example, the marker bit is set to 1 for the last packet of the frame. For other frames it is set to be zero. The sequence number is initialised to 0 and incremented by 1 for each packet. The time stamp is copied from the incoming packets from the camera. The time stamps are stored in the index file 302, and read to the engine thread 604 into the corresponding data structure. Once all values are set, a composing function (ComposeRTPPacket( )) creates RTP packets by adding the 12 byte header with the supplied field values to the video packet. These video packets are streamed over UDP socket. The RTP stream can be played using an SDP file, which is supplied to the client at the time of connection establishment.

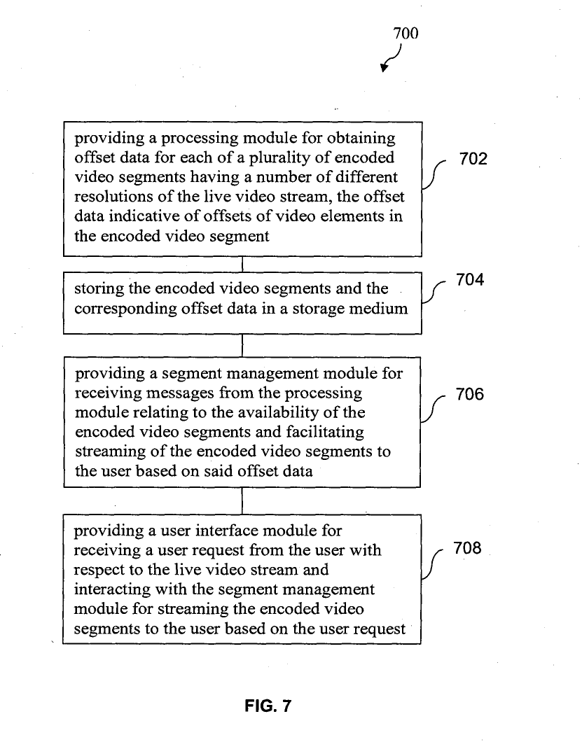

FIG. 7 depicts a flow chart of a method of enabling user control of a live video stream according to an embodiment of the present invention. In a first step 702, a processing module is provided for obtaining offset data for each of a plurality of encoded video segments having a number of different resolutions of the live video stream, the offset data indicative of offsets of video elements in the encoded video segment. In a second step 704, the encoded video segments and the corresponding offset data are stored in a storage medium. In a third step 706, a segment management module is provided for receiving messages from the processing module relating to the availability of the encoded video segments and facilitating streaming of the encoded video segments to the user based on the offset data. In a fourth step 708, a user interface module is provided for receiving a user request from a user with respect to the live video stream and communicating with the segment management module for streaming the encoded video segments to the user based on the user request.

Therefore, embodiments of the present invention provide a method and a system for enabling user control of live video stream(s), for example but not limited to, virtual zooming, virtual panning and/or sharing functionalities. Accordingly, a solution is provided for virtualizing a camera in a live video scenario while scaling for multiple cameras and for multiple users. The live video here is compressed video. Furthermore, the concept of tiling by localizing motion vector information, and slice length set to tile width has been used. This helps perform compressed-domain cropping of the RoI (most crucial for camera virtualization) without having to use a complex dependency tree. It is impractical to build this tree in a live streaming scenario.

The concept of tiling by limiting motion estimation to within tile regions helps to compose a frame with tiles selected from (a) completely different videos (b) selected from the camera but at different zoom levels. As result RoI streaming has been transformed to a rectangle composition problem for compressed video. This transformation helps in live RoI streaming for multiple users with different RoIs. Furthermore, the Region-of-Interest (RoI) transmission is achieved on compressed data unlike other methods that re-encode the video separately for different RoIs. As a result, we can support many different users' different RoI needs by encoding the video only once. Selective streaming of a specific region of an encoded video frame at a higher resolution is also possible so as to save on bandwidth. The selected region is operator specific. Using one encoded stream, multiple operators can view different regions of the same frame at different zoom levels. Such a scheme is useful in, for example, surveillance applications where high-resolution streams cannot be streamed by default (due to the transmission medium's limited bandwidth).

There are applications in in-stadium deployments for sporting and cultural events. Audience can view different camera views at low resolution on small screen devices (personal PDAs, Tablets, Phones) connected via a stadium-WiFi network. When they find that some region is interesting, then can virtually zoom and view that region alone at higher resolution. When they zoom in virtually, the bandwidth of the video remains as small as the default low-resolution case. As a result many more users can be supported. Further the devices do not drain battery very quickly as they always decode as much as the screen can support.

Advantageously, embodiments of the present invention allow users to share what they see in a live video feed with their social group as well as save views for future use. The zoom level that users see, and the RoI they view is shared as viewed. This is a new paradigm in live video systems.

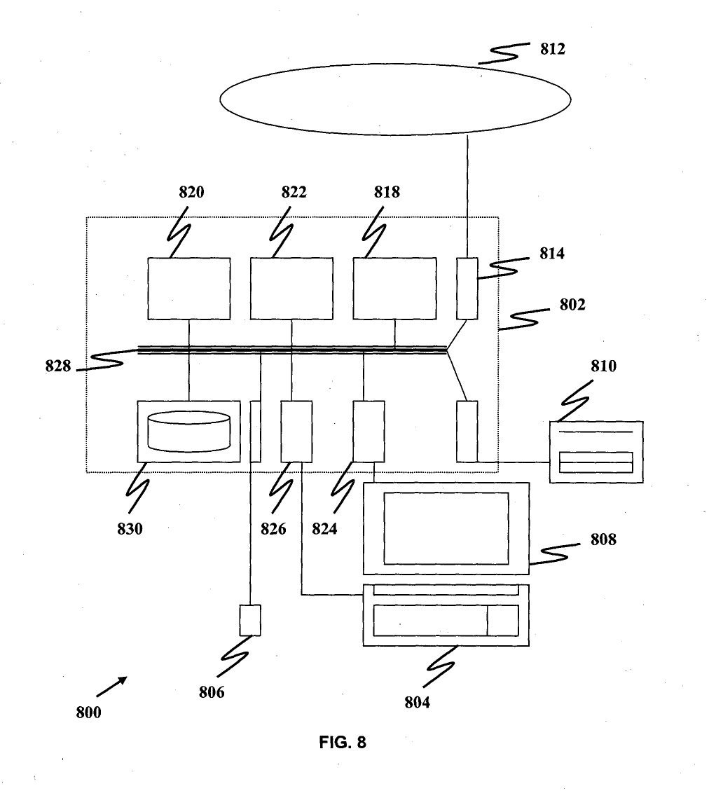

The method and system of the example embodiment can be implemented on a computer system 800, schematically shown in FIG. 8. The method may be implemented as software, such as a computer program being executed within the computer system 800, and instructing the computer system 800 to conduct the method of the example embodiment.

The computer system 800 comprises a computer module 802, input modules such as a keyboard 804 and mouse 806 and a plurality of output devices such as a display 808, and printer 810. The computer module 802 is connected to a computer network 812 via a suitable transceiver device 814, to enable access to e.g. the Internet or other network systems such as Local Area Network (LAN) or Wide Area Network (WAN). The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, and I/O interface 826 to the keyboard 804. The components of the computer module 802 typically communicate via an interconnected bus 828 and in a manner known to the person skilled in the relevant art.

The application program may be supplied to the user of the computer system 800 encoded on a data storage medium (e.g., DVD/CD-ROM or flash memory carrier) or downloaded via a network. The application program may then be read utilising a corresponding data storage medium drive of a data storage device 830. The application program is read and controlled in its execution by the processor 818. Intermediate storage of program data may be accomplished using RAM 820.

It will be appreciated to a person skilled in the art that the user may view the live video streaming via a software program or an application installed in a mobile device 620 or a computer. The application when executed by a processor of mobile device or the computer is operable to receive data from the system 100 for streaming live video to the user and is also operable to send user requests to the systems 100 as described above according to embodiments of the present invention. For example, the mobile device 620 may be a smartphone (e.g., an Apple iPhone® or BlackBerry®), a laptop, a personal digital assistant (PDA), a tablet computer, and/or the like. The mobile applications (or “apps”) may be supplied to the user of the mobile device 100 encoded on a data storage medium such as a flash memory module or memory card/stick and read utilising a corresponding memory reader-writer of a data storage device 128. The mobile application is read and controlled in its execution by the processor 116. Intermediate storage of program data may be accomplished using RAM 118. With current state-of-the-art smartphones, mobile applications are typically downloaded onto the mobile device 100 wirelessly through digital distribution platforms, such as iOS App Store and Android Google Play. As known in the art, mobile applications executable by a mobile device may be created by a user for performing various desired functions using Software Development Kits (SDKs) or the like, such as Apple iPhone® iOS SDK or Android® OS SDK.

It will be appreciated by a person skilled in the art that numerous variations and/or modifications may be made to the present invention as shown in the specific embodiments without departing from the scope of the present invention as broadly described. The present embodiments are, therefore, to be considered in all respects to be illustrative and not restrictive.

What is claimed:

1. A system for enabling user control of a live video stream, the system comprising:
a processing module for obtaining offset data for each of a plurality of encoded video segments having a number of different resolutions of the live video stream, the offset data indicative of offsets of video elements in the encoded video segment;
a storage medium for storing the encoded video segments and the corresponding offset data;
a segment management module for receiving messages from the processing module relating to the availability of the encoded video segments and facilitating streaming of the encoded video segments to the user based on said offset data; and
a user interface module for receiving a user request from a user with respect to the live video stream and communicating with the segment management module for streaming the encoded video segments to the user based on the user request.

2. The system according to claim 1, wherein the encoded video segments are encoded based on a virtual tiling technique where each frame of the encoded video segments is divided into an array of tiles, and each tile comprising an array of slices.

3. The system according to claim 1, wherein the processing module is operable to receive and process the live video stream into said encoded video segments at said number of different resolution levels.

4. The system according to claim 1, further comprising a camera for producing the live video stream and processing the live video stream into said encoded video segments at said number of different resolutions levels.

5. The system according to claim 1, wherein the processing module is operable to parse the encoded video segments for determining said offsets of video elements in each encoded video segment.

6. The system according to claim 1, wherein for each encoded video segment, the offset data corresponding to said encoded video segment are included in an index file associated with said encoded video segment.

7. The system according to claim 1, wherein the segment management module comprises a queue of a predetermined size for storing references to the offset data and the encoded video segments based on the messages received from the processing module.

8. The system according to claim 7, wherein the segment management module is operable to load the offset data referred to by each reference in the queue into a data structure in the storage medium for facilitating streaming of the encoded video segment associated with the offset data.

9. The system according to claim 1, wherein the video elements in the encoded video segment comprise a plurality of frames, a plurality of tiles in each frame, and a plurality of slices in each tile.

10. The system according to claim 9, wherein the offset data comprises data indicating byte offset of each frame, byte offset of each tile in each frame, and byte offset of each slice in each tile.

11. The system according to claim 10, wherein the byte offsets of the video elements in the encoded video segment are determined with respect to a start of the encoded video segment.

12. The system according to claim 1, wherein the user interface module is configured for receiving and processing the user request from the user with respect to the live video stream, the user request including an adjustment of region-of-interest coordinates, an adjustment of zoom level, and/or sharing the live video stream being viewed at the user's current viewing parameters with others.

13. The system according to claim 12, wherein the viewing parameters include region-of-interest coordinates and zoom level determined based on the user request, and wherein a user viewing data, comprising the viewing parameters, is stored in the storage medium linked to the user.

14. The system according to claim 13, wherein the user interface module is operable to update the user viewing data with the adjusted region-of-interest coordinates when the adjustment of the region-of-interest coordinates is requested by the user, and is operable to extract the tiles of the encoded video segments intersecting and within the adjusted region-of-interest coordinates for streaming to the user based on the offset data associated with the encoded video segments loaded on the storage medium.

15. The system according to claim 13, wherein the user interface module is operable to update the user viewing data with the adjusted zoom level and region-of-interest coordinates when the adjustment of the zoom level is requested by the user, and is operable to extract the tiles of the encoded video segments at the resolution closest to the adjusted zoom level and intersecting and within the adjusted region-of-interest coordinates for streaming to the user based on the offset data associated with the encoded video segments loaded on the storage medium.

16. The system according to claim 13, wherein the user interface module is operable to extract the viewing parameters from the user viewing data when the sharing of the live video stream with others is requested by the user, and to create a video description file comprising the viewing parameters for enabling a video footage to be reproduced or to create a video footage based on the viewing parameters, and wherein a reference data linked to the video description file or the video footage is created for sharing with said others to view the video footage.

17. The system according to claim 12, further comprising a display module for receiving the user request with respect to the live video stream and transmitting the user request to the user interface module, and for receiving and decoding tiles of the encoded video segments from the user interface module for displaying to the user based on the user request.

18. The system according to claim 17, wherein the display module is operable to crop and scale the decoded tiles for display based on the user request for removing slices within the decoded tiles not within the region-of-interest coordinates.

19. The system according to claim 18, wherein the display module is operable to, upon receiving the user request and before the arrival of the tiles having a higher resolution corresponding to the user request, decode and display other tiles having a lower resolution at a same position as the tiles.

20. The system according to claim 1, wherein the system is operable to receive and process a plurality of the live video streams or encoded video segments from a plurality of cameras for streaming to multiple users.

21. A method of enabling user control of a live video stream, the method comprising:
providing a processing module for obtaining offset data for each of a plurality of encoded video segments having a number of different resolutions of the live video stream, the offset data indicative of offsets of video elements in the encoded video segment;
storing the encoded video segments and the corresponding offset data in a storage medium;
providing a segment management module for receiving messages from the processing module relating to the availability of the encoded video segments and facilitating streaming of the encoded video segments to the user based on said offset data; and
providing a user interface module for receiving a user request from the user with respect to the live video stream and interacting with the segment management module for streaming the encoded video segments to the user based on the user request.

22. A computer program product, embodied in a computer-readable storage medium, comprising instructions executable by a computing processor to perform the method of claim 21.
